(19) United States
(12) Patent Application Publication
(10) Pub. No.: US 2005/0259374 A1
(43) Pub. Date: Nov. 24, 2005

(54) Network-based electrical unit on/off switching control method and system

(75) Inventor: Chang-Chin Lai, Taipei (TW)

Correspondence Address: Mr. Peter F. Corless;EDWARDS & ANGELL, LLP, 101 Federal Street, Boston, MA, 02110, US

(73) Assignee: Inventec Corporation

(21) Appl. No.: 10/850,909

(22) Filed: May 21, 2004

(51) Int. Cl. H02H 3/24

(52) U.S. Cl. 361/90

(57) ABSTRACT

A network-based electrical unit on/off switching control method and system is proposed, which is designed for use in conjunction with a network system for a client workstation to control the ON/OFF status of one or more electrical units, and which is characterized by the capability of allowing the user to browse the respective installed locations of the electrical units as well as the ON/OFF status thereof, and further allows the user to switch the ON/OFF status of these electrical units remotely via this/her client workstation. This feature allows new employers to an enterprise or company to quickly learn about where to find the ON/OFF switches of the electrical units in the office and conference rooms where they work, so that they can quickly get familiar with their working environments.

### BACKGROUND OF THE INVENTION

1. Field of the Invention

This invention relates to network-based information technology, and more particularly, to a network-based electrical unit on/off switching control method and system which is designed for use in conjunction with a network system, such as Internet, intranet/extranet, LAN (Local Area Network), and so on, for providing a network-based electrical unit on/off switching control function that allows a user to utilize a network-linked client workstation to check the installed locations and ON/OFF status of various electrical units, such as lighting units, air conditioners, electronically-controlled door/window units, and so on, that are installed at a particular site, such as an office building, and further allows the user to switch the ON/OFF status of these electrical units remotely via the network system.

2. Description of Related Art

An enterprise or company's office building are often constructed with a large number of office and conference rooms, each being installed with various kinds of electrical units such as lighting units, air conditioners, electronically-controlled door/window units, and so on. Typically, these electrical units are provided with ON/OFF switches arranged at nearby locations to allow the user to switch the ON/OFF status of these electrical units.

However, since modern office buildings of large enterprises are typically constructed with large and wide office or conference rooms, it would often make new employers

However, since modern office buildings of large enterprises are typically constructed with large and wide office or conference rooms, it would often make new employers confused about the locations of the ON/OFF switches of the electrical units in the office or conference rooms where they work. This problem would undoubtedly affect the employers' working efficiency.

### SUMMARY OF THE INVENTION

It is therefore an objective of this invention to provide a network-based electrical unit on/off switching control method and system which allows a user to browse the installed locations of all electrical units at a particular site, and further allows the user to switch the ON/OFF status of these electrical units remotely via network.

The network-based electrical unit on/off switching control method and system according to the invention is designed for use in conjunction with a network system, such as Internet, intranet/extranet, LAN (Local Area Network), and so on, for providing a network-based electrical unit on/off switching control function that allows a user to utilize a network-linked client workstation to check the installed locations and ON/OFF status of various electrical units, such as lighting units, air conditioners, electronically-controlled door/window units, and so on, that are installed at a particular site, such as an office building, and further allows the user to switch the ON/OFF status of these electrical units remotely via the network system.

The network-based electrical unit on/off switching control method and system according to the invention is characterized by the capability of allowing a user to browse the respective installed locations of electrical units as well as the ON/OFF status thereof, and further allows the user to switch the ON/OFF status of these electrical units remotely via this/her client workstation. This feature allows new employers to an enterprise or company to quickly learn about where to find the ON/OFF switches of the electrical units in the office and conference rooms where they work, so that they can quickly get familiar with their working environments.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and the object-oriented component model of the network-based electrical unit on/off switching control system according to the invention; and

FIG. 2 is a computer screen graphic diagram showing an example of an electrical unit installation plan displayed by the network-based electrical unit on/off switching control system of the invention on an actively-linked workstation.

### DETAILED DESCRIPTION OF PREFERRED EMBODIMENTS

The network-based electrical unit on/off switching control method and system according to the invention is disclosed in full details by way of preferred embodiments in the following with reference to the accompanying drawings.

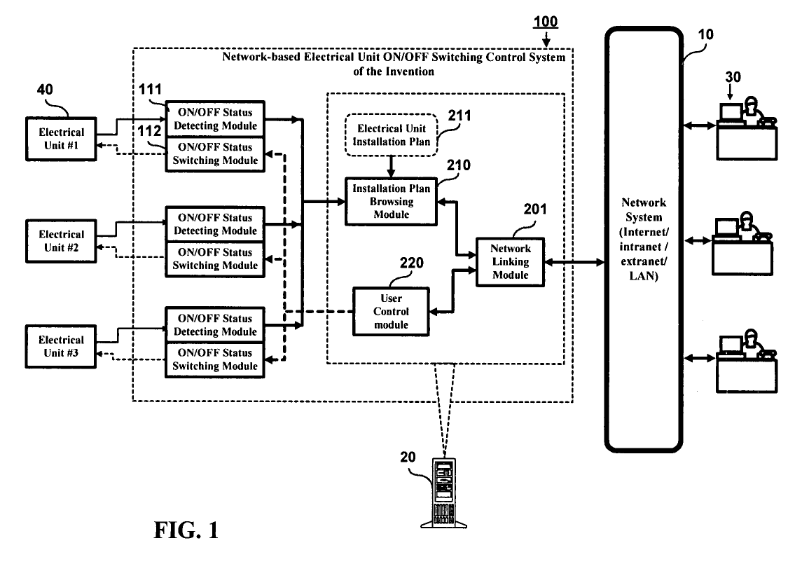

FIG. 1 is a schematic diagram showing the application architecture and object-oriented component model of the network-based electrical unit on/off switching control system according to the invention (as the part enclosed in the dotted box indicated by the reference numeral 100). As shown, the network-based electrical unit on/off switching control system of the invention 100 is designed for use in conjunction with a network system 10, such as Internet, intranet/extranet, LAN (Local Area Network), and so on, for providing a network-based electrical unit on/off switching control function by way of a server 20 linked to the network system 10 to a client workstation 30 linked to the server 20 via the server 20 to allow the user to check the respective installed locations and ON/OFF status of a set of various kinds of electrical units 40, including, for example, lighting units, air conditioners, electronically-controlled door/window units, and so on, that are installed at a particular site, such as an office building, and further allows the user to switch the ON/OFF status of these electrical units 40 remotely via the network system 10.

The object-oriented component model of the network-based electrical unit on/off switching control system of the invention 100 comprises: (a1) an ON/OFF status detecting module 111; (a2) an ON/OFF status switching module 112; (b1) a network linking module 201; (b2) an installation plan browsing module 210; and (b3) a user control module 220. In practical implementation, for example, the ON/OFF status detecting module 111 and the ON/OFF status switching module 112 are implemented as a combined hardware device coupled to each of the electrical units 40, while the network linking module 201, the installation plan browsing module 210, and the user control module 220 are implemented as a software package installed on the server 20.

The ON/OFF status detecting module 111 is coupled to each of the electrical units 40 for detecting the ON/OFF status of each of the electrical units 40, and which is capable of generating an ON/OFF status description message indicative the ON/OFF status of each of the electrical units 40 and send this ON/OFF status description message directly to the installation plan browsing module 210 on the server 20.

The ON/OFF status switching module 112 is also coupled to each of the electrical units 40, and which is capable of switching the ON/OFF status of each of the electrical units 40 in response to a switching enable message from the user control module 220.

The network linking module 201 is installed on the server 20, and which is connected to the network system 10 for any user to utilize a computer unit as a client workstation 30 to link via the network system 10 to the network-based electrical unit on/off switching control system of the invention 100. This network linking module 201 can optionally include a password-checking login function to the actively-linked client workstation 30 for checking whether the user is authorized to use the network-based electrical unit on/off switching control system of the invention 100; i.e., the user can gain access to the network-based electrical unit on/off switching control system of the invention 100 only if he/she is an authorized user who has a valid password.

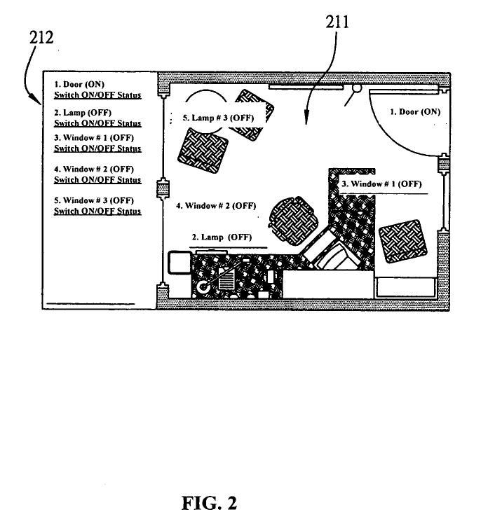

The installation plan browsing module 210 is capable of serving up a graphically represented electrical unit installation plan 211 shown in FIG. 2 via the network system 10 to any client workstation 30 that is currently actively linked via the network system 10 to the server 20, where the electrical unit installation plan 211 is used to show the respective installed locations of all the electrical units 40. This allows the user to learn the installed location of each of the electrical units 40 by simply browsing over the electrical unit installation plan 211. In addition, the installation plan browsing module 210 is capable of displaying the ON/OFF status of each of the electrical units 40 in the electrical unit installation plan 211 based on the ON/OFF status description message from the ON/OFF status detecting module 111. Further, the electrical unit installation plan 211 provides an ON/OFF status switching function for each of the electrical units 40. In the embodiment of FIG. 2, for example, the electrical unit installation plan 211 provides an [ON/OFF Switching] button 212 which allows the user to switch the ON/OFF status of a selected one of the electrical units 40 by simply clicking on this [ON/OFF Switching] button 212 with mouse or other kind of point device. In actual implementation, for example, the electrical unit installation plan 211 is presented through a Web page displayed on the client workstation 30; i.e., the server 20 is implemented as a Web page server to serve up the electrical unit installation plan 211 in a Web page via the network system 10 to the client workstation 30.

The user control module 220 is installed on the server 20, and which is capable of generating a switching enable message in response to a user-initiated control event, such as in the event of the user clicking on the [ON/OFF Switching] button 212 in the electrical unit installation plan 211 with mouse when the electrical unit installation plan 211 is being displayed on the client workstation 30, and then transferring the switching enable message to the ON/OFF status switching module 112 to activate the ON/OFF status switching module 112 to switch the ON/OFF status of the user-specified one of the electrical units 40.

Referring together to FIG. 1 and FIG. 2, in practical application, the network-based electrical unit on/off switching control system of the invention 100 can be installed, for example, in an enterprise's office building for the employers working within the office building to learn the respective installed locations of all the electrical units 40 which are provided in various office and conference rooms in the building. During actual operation, the user needs first to link his/her workstation 30 via the network system 10 to the server 20 to gain access to the network-based electrical unit on/off switching control system of the invention 100. When linked, the network-based electrical unit on/off switching control system of the invention 100 will download a Web page to the actively-linked client workstation 30, allowing the user to perform a login procedure through the network linking module 201. After login, the installation plan browsing module 210 is activated to download an electrical unit installation plan 211 via the network system 10 to the client workstation 30 for the user to browse the respective installed locations and ON/OFF status of the electrical units 40 and where their associated ON/OFF switches are installed.

If the user wishes to turn ON or OFF a certain one of the electrical units 40 via the client workstation 30, the user can simply use mouse or other kind of pointing device to click on the [ON/OFF Switching] button 212 in the electrical unit installation plan 211 to issue a user-initiated control event that causes the ON/OFF status switching module 112 to be activated to switch the ON/OFF status of the user-specified one of the electrical units 40.

In conclusion, the invention provides a network-based electrical unit on/off switching control method and system which is designed for use in conjunction with a network system for a client workstation linked to the network system to control the ON/OFF status of a set of electrical units, and which is characterized by the capability of allowing the user to browse the respective installed locations of the electrical units as well as the ON/OFF status thereof, and further allows the user to switch the ON/OFF status of these electrical units remotely via this/her client workstation. This feature allows new employers to an enterprise or company to quickly learn about where to find the ON/OFF switches of the electrical units in the office and conference rooms where they work, so that they can quickly get familiar with their working environments. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A network-based electrical unit on/off switching control method for on a network system for a client workstation linked to the network system to control the ON/OFF status of at least one electrical unit;
the network-based electrical unit on/off switching control method comprising:
detecting the ON/OFF status of the electrical unit to thereby generate an ON/OFF status description message indicative the ON/OFF status of the electrical unit being detected;
building an electrical unit installation plan which shows the installed location of the electrical unit as well as the ON/OFF status thereof based on the ON/OFF status description message;
downloading the electrical unit installation plan via the network system to the client workstation;
while the electrical unit installation plan is being displayed on the client workstation, responding to a user-initiated control event to generate an switching enable message; and
responding to the switching enable message to switch the ON/OFF status of the electrical unit.

2. The network-based electrical unit on/off switching control method of claim 1, wherein the type of the electrical unit is selected from the group comprising lighting unit, air conditioner, and electronically-controlled door/window unit.

3. The network-based electrical unit on/off switching control method of claim 1, wherein the network system includes Internet.

4. The network-based electrical unit on/off switching control method of claim 1, wherein the network system includes an intranet system.

5. The network-based electrical unit on/off switching control method of claim 1, wherein the network system includes an extranet system.

6. The network-based electrical unit on/off switching control method of claim 1, wherein the network system includes an LAN (Local Area Network) system.

7. The network-based electrical unit on/off switching control method of claim 1, wherein the electrical unit installation plan is displayed on the client workstation through a Web page.

8. The network-based electrical unit on/off switching control method of claim 1, further comprising:
a password-checking login procedure for checking the authorization status of the client workstation via password checking.

9. A network-based electrical unit on/off switching control system for use in conjunction with a network system for a client workstation linked to the network system to control the ON/OFF status of at least one electrical unit;
the network-based electrical unit on/off switching control system comprising:
an ON/OFF status detecting module, which is coupled to the electrical unit for detecting the ON/OFF status of the electrical unit, and which is capable of generating an ON/OFF status description message indicative the ON/OFF status of the electrical unit being detected;
a network linking module, which is connected to the network system for the client workstation to link via the network system to this network-based electrical unit on/off switching control system;
an installation plan browsing module, which is capable of serving up an electrical unit installation plan via the network system to the client workstation, where the electrical unit installation plan is used to show the installed location of the electrical unit as well as the ON/OFF status thereof based on the ON/OFF status description message from the ON/OFF status detecting module;
a user control module, which is capable of generating a switching enable message in response to a user-initiated control event that intends to switch the ON/OFF status of the electrical unit; and
an ON/OFF status switching module, which is coupled to the electrical unit, and which is capable of being activated in response to the user-initiated control event from the user control module to switch the ON/OFF status of the electrical unit.

10. The network-based electrical unit on/off switching control system of claim 9, wherein the type of the electrical unit is selected from the group comprising lighting unit, air conditioner, and electronically-controlled door/window unit.

11. The network-based electrical unit on/off switching control system of claim 9, wherein the network system includes Internet.

12. The network-based electrical unit on/off switching control system of claim 9, wherein the network system includes an intranet system.

13. The network-based electrical unit on/off switching control system of claim 9, wherein the network system includes an extranet system.

14. The network-based electrical unit on/off switching control system of claim 9, wherein the network system includes an LAN (Local Area Network) system.

15. The network-based electrical unit on/off switching control system of claim 9, wherein the installation plan browsing module displays the electrical unit installation plan through a Web page.

16. The network-based electrical unit on/off switching control system of claim 9, wherein the network linking module includes a password-checking login function for providing a password-checking login procedure to the client workstation.
